(19) United States
(12) Patent Application Publication
(10) Pub. No.: US 2008/0174819 A1
(43) Pub. Date: Jul. 24, 2008

(54) IMAGE FORMING APPARATUS AND CONTROL METHOD THEREOF

(75) Inventor: Manabu Hada, Kawasaki-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 12/017,621

(22) Filed: Jan. 22, 2008

(30) Foreign Application Priority Data
Jan. 22, 2007 (JP) 2007-011953

(51) Int. Cl. G06K 1/00

(52) U.S. Cl. 358/1.15

(57) ABSTRACT

A reduction of consumption power and shortening of a processing time are achieved at the same time in a cooperative image forming system. When a user logs in an MFP-A, the MFP-A refers to workflow information associated with the user. If the workflow information uses a hot folder of another MFP, the MFP-A requests that MFP to send a work detail notification indicating the work details of the hot folder. The MFP-A requests the other MFP to recover power supplies of processing units of hardware used in the hot folder to a normal mode. After that, the MFP-A transmits data to the hot folder provided by the other MFP used in the workflow.

### BACKGROUND OF THE INVENTION

1. Field of the Invention

The present invention relates to an image forming apparatus of an electrophotography system or the like, to which an image forming apparatus that allows a cooperative operation or the like is connected, and a control method thereof and, more particularly, to an apparatus and method which can achieve savings of both consumption energy and high-speed processing.

2. Description of the Related Art

In recent years, a multi-function printer (to be referred to as an MFP hereinafter) which provides, to the user, a printer function, facsimile transmission and reception functions, scan image transmission and reception functions, e-mail transmission and reception function, and the like in addition to a copy function has appeared. Recently, a cooperative image forming system which shares the workload of printing by transferring image data among a plurality of MFPs is also available. The cooperative image forming system allows efficient processing for sharing a job to be processed to respective MFPs (e.g., the system controls the two MFPs to each print 50 copies out of 100 copies of documents). In the cooperative image forming system, for example, one MFP serves as a master MFP which accepts a workflow, and the other MFP serves as a slave MFP which processes a job shared from the workflow by the master MFP.

On the other hand, a demand has arisen for lower power consumption of general electronic devices, and an MFP is added with a function which makes the MFP go to a low power consumption mode (sleep mode) when the MFP is not used. For this reason, upon executing the processing of a workflow by the cooperative image forming system, the slave MFP may be in a sleep mode in some cases. In such mode, since the slave MFP cannot quickly recover from the sleep mode in its processing turn, the processing of the workflow is delayed.

In order to solve the above problem, an image forming system which cancels a low power consumption mode of a slave MFP and shifts the slave MFP to a printable mode when a master MFP issues a connection request while the slave MFP is in the low power consumption mode has been proposed (for example, see Japanese Patent Laid-Open No. 11-157172).

A technique which issues a recovery request to a printable mode to a slave MFP ahead of transmission of image data in consideration of a warm-up time of a fixing device of the slave MFP to skip the time required for warming up has been proposed (for example, see Japanese Patent Laid-Open No. 2004-237468).

The techniques described in the aforementioned prior art references are premised on that the master and slave MFPs share the load of an identical print work, and a mode to which the MFP is to be recovered is predetermined.

However, distribution of processes of a workflow includes a function distribution type, which controls a master MFP to execute a print work and a slave MFP to transmit FAX or e-mail data, or controls respective MFPs to execute different processes using a hot folder function of the MFPs. Upon execution of a workflow which controls the master and slave MFPs to execute different works, the following problems occur.

With the techniques described in the aforementioned prior art references, since the mode to which the MFP is to be recovered is predetermined, the MFP may be recovered to a mode which is not related to a function to be executed. For example, when the slave MFP is utilized to process a workflow including no print work, if the master MFP is recovered to a printable mode, the slave MFP is also recovered to the printable mode. If the slave MFP does not execute any print processing, the slave MFP wastes electric power.

Since the master MFP cannot know the power supply mode of the slave MFP, if the power switch of the slave MFP is OFF, the process assigned to the slave MFP is not executed, thus stopping the workflow. However, the master MFP does not have any means for detecting the power supply mode of the slave MFP.

### SUMMARY OF THE INVENTION

The present invention has been made in consideration of the aforementioned related arts, and has as its object to achieve low power consumption and speeding up of processes of a cooperative image forming system by recovering a slave MFP to a mode required for a work of interest.

It is another object of the present invention to prevent an interruption of a workflow due to power OFF of an image forming apparatus which forms a cooperative image forming system.

In order to achieve the above objects, the present invention comprises the following arrangement. That is, there is provided an image forming apparatus, which can communicate with another image forming apparatus that executes a process based on a hot folder function of applying a predetermined process to data input to a predetermined storage location, and which can execute a workflow as a set of processes by combining a plurality of process steps, the apparatus comprises:

a determination unit adapted to determine a processing unit required for the process using the hot folder function provided by the other image forming apparatus based on information associated with the hot folder function received from the other image forming apparatus;

a request unit adapted to transmit, when a workflow including a process step using the hot folder function is selected, a recovery request, which requests to recover a power supply of the processing unit determined by the determination unit to a running mode, to the other image forming apparatus that provides the hot folder function; and

a data transmission unit adapted to transmit data to be processed by the hot folder function provided by the other image forming apparatus to the other image forming apparatus after the request unit transmits the recovery request.

According to the present invention, since a slave MFP is recovered to a mode required for a work of interest, a low power consumption and speeding up of processes of a cooperative image forming system can be achieved at the same time.

Also, an interruption of a workflow due to power OFF of an image forming apparatus which forms a cooperative image forming system can be prevented.

Further features of the present invention will become apparent from the following description of exemplary embodiments with reference to the attached drawings.

### BRIEF DESCRIPTION OF THE DRAWINGS

FIG. 1 is a flowchart for explaining the first embodiment;

FIG. 2 is a diagram showing the arrangement of a network system configured according to one embodiment of the present invention;

FIG. 3 is a power consumption transition graph for explaining the first embodiment;

FIG. 4 is a sectional view for explaining the structure of a multi-function system;

FIG. 5 is a block diagram of an electrophotography apparatus;

FIG. 6 shows an operation unit of the electrophotography apparatus; and

FIG. 7 shows an example of hot folder information.

### DESCRIPTION OF THE EMBODIMENTS

### First Embodiment

<Overview of Distributed Processes>

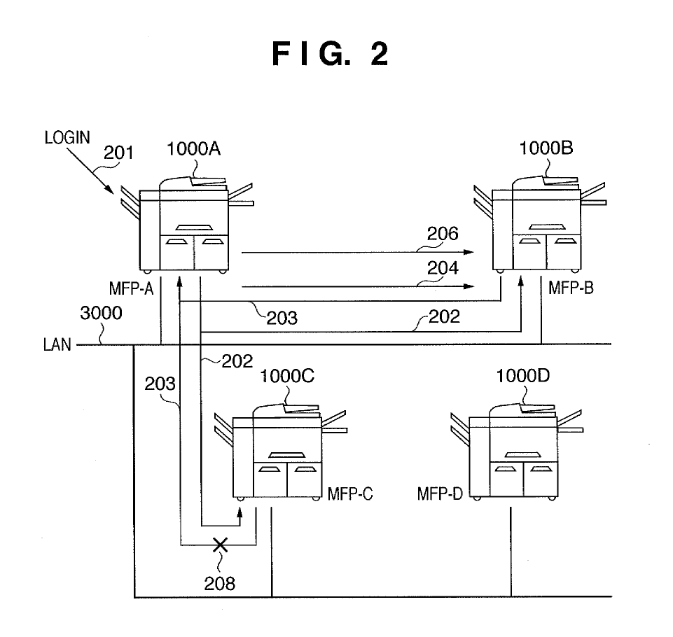

FIG. 2 is a diagram of a network used to explain this embodiment, and shows that a plurality of image forming apparatuses (MFPs including an MFP-A, MFP-B, MFP-C, and MFP-D in this example) are connected. Referring to FIG. 2, the respective MFPs are connected via a network 3000 (for example, a LAN). The respective MFPs are image forming apparatuses which can use a hot folder function.

Each MFP can define a hot folder. The hot folder means the storage location (i.e., a folder) of data associated with a set of processes. However, the hot folder does not always store data but it may be an entrance of data associated with a set of processes. When data is input to the hot folder, a process associated with that hot folder is executed for that data. The user can define a name unique to the hot folder, and a process associated with the hot folder having that name. The defined name and process contents are saved in a nonvolatile storage device of that MFP as information representing them. The user can input the definition of the hot folder via a user interface provided when the MFP executes a program.

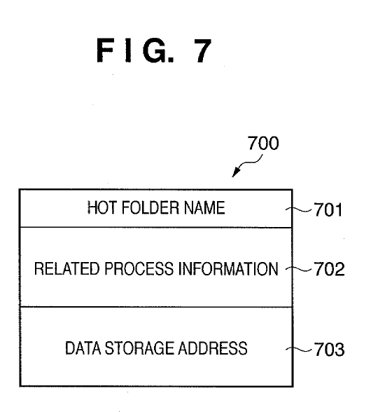

FIG. 7 shows an example of hot folder information 700 which is saved in the MFP and defines the hot folder. The hot folder information includes a hot folder name 701, associated process information 702, and a data storage address 703 of input data.

When a certain hot folder is designated as a storage destination of data, and data is input, the hot folder information 700 is referred to, and the input data is stored at an address designated by the data storage address 703. Upon completion of storage of the data or when a process is ready to execute even during storage, a process module designated by the process information 702 is launched. In this case, the address of the data saved in the hot folder and the like are passed to the process module as parameters indicating the data to be processed. Of course, this explanation is an example, and a hot folder can be implemented by other methods.

When the plurality of MFPs according to the present invention form a cooperative image forming system, they implement process distribution using this hot folder. For example, an operator operates an operation panel of one MFP which forms the cooperative image forming system, and acquires information of hot folders provided by the cooperative image forming system. The operator can select a desired hot folder with reference to the acquired information of the hot folders, and can designate input data to the selected hot folder. A set of processes defined by combining a plurality of processes designated in this way will be referred to as a workflow hereinafter. As the workflow, this embodiment calls and re-uses a workflow which is designated in advance and is saved. However, a workflow may be set every time it is executed.

For example, when one hot folder is used in the workflow, the identifier of that hot folder, an input source of data to the hot folder, and the identifier of an MFP which provides the hot folder are set in the workflow. The settings are saved as workflow information. In case of a workflow using a plurality of hot folders, an input source of data is designated for each hot folder. The input source of data is a scanner equipped on a given MFP, a file that saves data, and the like. By designating a file as an input source, step-by-step processes by links of the hot folders can be implemented.

The MFP saves workflow information indicating the defined workflow in its nonvolatile memory, and executes workflow processes according to the workflow information in response to an input trigger. A hot folder used in the workflow may often be defined by another MFP (to be referred to as a slave MFP or another MFP hereinafter) which is not an MFP that executes the workflow (to be referred to as a master MFP hereinafter). Note that the slave MFP receives data transmitted from an MFP different from that slave MFP and executes a process, and can communicate with the master MFP. In this case, the master MFP transmits data from the designated input source to the designated hot folder of the slave MFP as a destination. Upon reception of data in the hot folder, the slave MFP executes the process associated with that hot folder for the input data as data to be processed. Note that the master MFP may be fixed in the cooperative distributed processing system, but may be dynamically determined. In this embodiment, an MFP for which the user has made a login serves as a master MFP for that user. When the master MFP is called an image forming apparatus, the slave MFP is often called an external apparatus in distinction from the image forming apparatus.

As described above, in this embodiment, a cooperative distributed processing system using the hot folders is implemented. The invention according to this embodiment will be described in more detail hereinafter under the condition of the aforementioned operations.

FIG. 2 shows an overview of operations and messages. Referring to FIG. 2, the user executes a login operation at an operation unit of the MFP-A (201). If the login operation has succeeded, the MFP-A serves as a master MFP and refers to workflow information associated with the login user. The MFP-A issues a work information request to another MFP which defines a hot folder used in that workflow (202). For example, assume that the MFP-A saves workflows 1 to 3 as those for user A, and workflow 1 includes a step of executing a process using hot folder B of the MFP-B. Furthermore, assume that workflow 3 includes a step of executing a process using hot folder C of the MFP-C. In this case, the MFP-A issues a work information request of hot folder B to the MFP-B, and a work information request of hot folder C to the MFP-C. This work information corresponds to hot folder information defined by the corresponding slave MFP. Upon reception of the work information request, the slave MFP returns work information to the master MFP-A as a request source of the work information (203). Although not shown in FIG. 2, a work information request may be issued to the MFP-D. A work information request target may be all MFPs which form the cooperative image forming system or may be a predetermined MFP.

Upon reception of the work information, the MFP-A displays the work information, i.e., the hot folder information provided by the cooperative image processing system on its operation unit (operation panel) or the like. The master MFP has information which associates displayed hot folders and the MFPs which provide them. The operator can select a workflow with reference to the displayed work information. The master MFP-A checks if the workflow selected on its operation unit uses a hot folder of the slave MFP. If the selected workflow uses a hot folder of the slave MFP, the master MFP issues, to the slave MFP, a recovery request of a power supply of a hardware resource used for the process associated with the hot folder to be used to a normal running mode (204).

For example, assume that the workflow selected on the MFP-A uses a hot folder of the MFP-B, i.e., it includes an operation request of the MFP-B. In this case, the MFP-A transmits, to the MFP-B via the network, a recovery request of only a power supply of a part corresponding to the work details of the hot folder of the MFP-B, i.e., only a power supply of hardware used in the process associated with that hot folder.

Upon reception of the power supply recovery request, the slave MFP recovers only the power supply corresponding to the requested hardware. After that, the MFP-A as a master transmits data to the MFP-B as a slave (206).

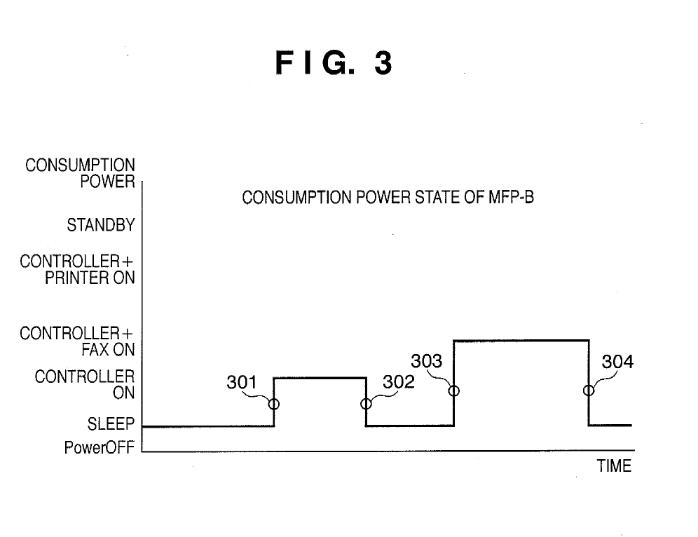

FIG. 3 is a graph showing an example of transition of power consumption in the slave MFP so as to give an explanation of this embodiment. The ordinate plots consumption power, and the abscissa plots an elapse of time. FIG. 3 is associated with the operation sequence of FIG. 2, and shows a temporal sequence upon explaining this embodiment. In the slave MFP in a sleep mode, upon reception of a request message of work information from the master MFP, a controller wakes up (301), and receives that message. After transmission of work information, the controller returns to the sleep mode again (302). After that, upon reception of a recovery request message which requests to recover a power supply, the slave MFP recovers, i.e., turns on the controller and the power supply to a hardware resource requested to be recovered (a facsimile unit in the example of FIG. 3) (303). Data is input to the hot folder of the slave MFP, and its process is executed. When a predetermined period of time elapses after completion of the process, the slave MFP returns the sleep mode again (304). In this manner, since only a required part is activated if it is required, an effect can be obtained in terms of power savings.

<Arrangement of MFP>

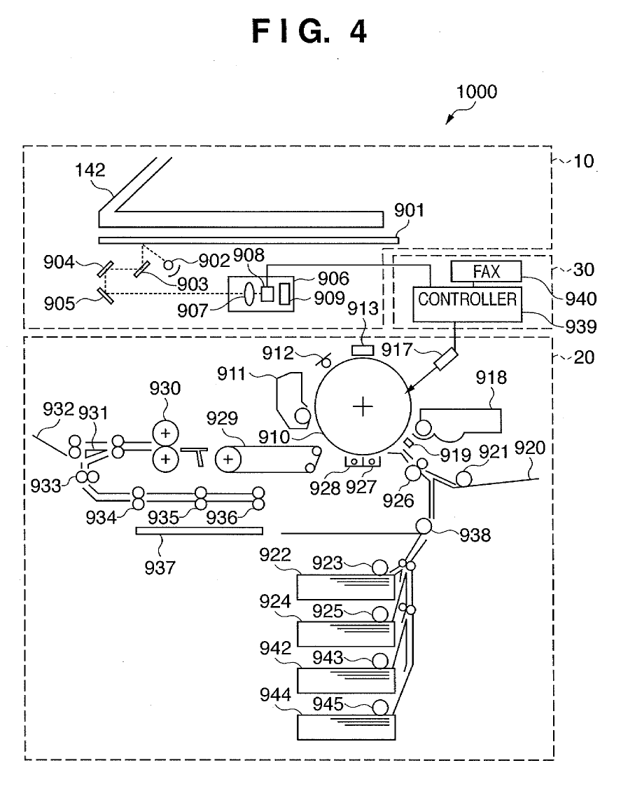

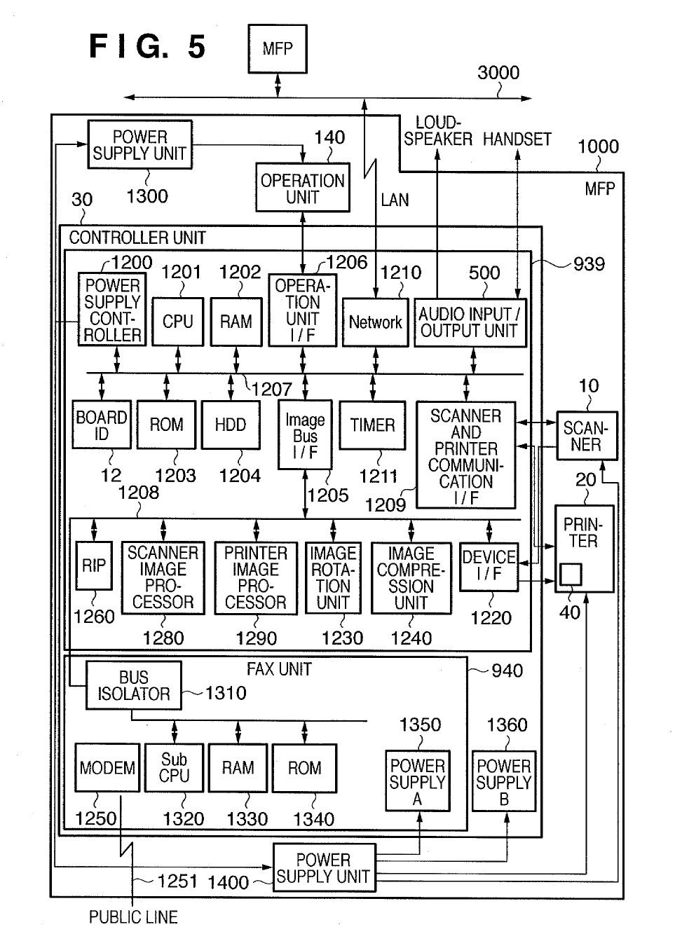

FIG. 4 is a sectional view for explaining the structure of the MFP shown in FIG. 2. Details of the operation will be described below with reference to FIG. 4. An MFP 1000 has a scanner unit 10, printer unit 20, controller unit 30, and power supply unit (shown in FIG. 5) for supplying electric power to these units.

In the scanner unit 10, a document fed from an auto document feeder 142 is sequentially placed at a predetermined position on a platen glass 901. A document illumination lamp 902 comprises, e.g., a halogen lamp, and exposes a document placed on the platen glass 901. Scan mirrors 903, 904, and 905 are housed in an optical scan unit (not shown) and guide light reflected by the document to an image signal output unit 906 while they are reciprocally moved. The image signal output unit 906 comprises an imaging lens 907 which provides a reflected image from the document on an image pickup device, an image pickup device 908 such as a CCD or the like, a driver 909 which drives the image pickup device 908, and the like. An image signal output from the image pickup device 908 is converted into, e.g., 8-bit digital data, and the digital data is then input to a controller 939 in the controller unit 30.

In the printer unit 20, a photosensitive drum 910 undergoes charge removal by a pre-exposure lamp 912 to prepare for image formation. A primary charger 913 uniformly charges the photosensitive drum 910. An exposure unit 917 comprises, e.g., a semiconductor laser and the like. The exposure unit 917 exposes the photosensitive drum 910 with a light beam, which is modulated based on image data processed by the controller 939 that controls image formation and the overall apparatus, thus forming an electrostatic latent image. A developer 918 houses a black developing agent (toner). A pre-transfer charger 919 applies a high voltage before a toner image developed on the photosensitive drum 910 is transferred onto a paper sheet. Paper feed units 922, 924, 942, and 944 have paper cassettes used to store paper sheets. A paper feed unit 920 is a manual insertion paper feed unit. From each paper feed unit, a paper sheet is fed into the apparatus by driving a feed roller 921, 923, 925, 943, or 945. The fed paper sheet temporarily stops at the layout position of registration rollers 926, and is re-fed in synchronism with the write start timing of an image formed on the photosensitive drum 910. A transfer charger 927 transfers the toner image developed on the photosensitive drum 910 onto the fed transfer paper sheet. A separation charger 928 separates the transfer paper sheet that has undergone the transfer operation from the photosensitive drum 910. Residual toner on the photosensitive drum 910 without being transferred is recovered by a cleaner 911. A conveyor belt 929 conveys the transfer paper sheet that has undergone the transfer process to a fixing device 930. The fixing device 930 fixes the toner image formed on the paper sheet by, e.g., heat. A flapper 931 controls the convey path of the transfer paper sheet that has undergone the fixing process to the layout direction of a sorter 932 or intermediate tray 937. Feed rollers 933 to 936 reverse (multiple) or non-reverse (double-sided) the transfer paper sheet one face of which has undergone the fixing process and fed it to the intermediate tray 937. A re-feed roller 938 conveys the transfer paper sheet placed on the intermediate tray 937 to the layout position of the registration rollers 926 again.

The controller unit 30 comprises the controller 939 and a FAX unit 940. The controller 939 comprises a microcomputer, image processor, and the like (to be described later), and controls the image forming operation and the like. The FAX unit 940 transmits FAX transmission and reception data to the image processor or a public line. A power supply unit (not shown) can independently supply electric power to the FAX unit 940, controller 939, and printer unit 20 under the control of the controller 939.

FIG. 5 is a block diagram showing the arrangement of the controller unit of the MFP 1000 shown in FIG. 4. The controller unit 30 is a controller which is connected to the scanner unit 10 as an image input device and the printer unit 20 as an image output device, and is connected to a LAN 3000 and public line (WAN) 1251 to input and output image information and device information. A CPU 1201 is a processor which controls the overall system. A RAM 1202 is a system work memory which is required to operate the CPU 1201 and also an image memory which temporarily stores image data. A ROM 1203 is a boot ROM, and stores a boot program of the system. An HDD 1204 is a hard disk drive, and stores system software, image data, a software counter value, and the like. A hot folder is also assured on the HDD 1204, and hot folder information is saved in the HDD 1204. When data is input to that hot folder, a workflow operation which is set in advance can be executed. The HDD 1204 also saves the software counter value. For the software counter values, a paper size-dependent counter area and a data processing size-dependent counter area are set, and are calculated and counted up with reference to an arbitrary reference size value which is set based on the data size processed by the CPU 1201. The storage areas of the counter values may be assured on an EEPROM (not shown) or the like in place of the HDD 1204 as long as they can be stored and held after power OFF.

An operation unit I/F 1206 is an interface with an operation unit (UI) 140, and outputs image data to be displayed on the operation unit 140 to it. Also, the operation unit I/F 1206 has a role of transmitting information input by the user of this system from the operation unit 140 to the CPU 1201. An audio input/output unit 500 controls to output an audio signal to a loudspeaker or to a handset, and to input an audio signal. A scanner and printer communication I/F 1209 is used to communicate with the CPUs of the scanner unit 10 and the printer unit 20. Using this interface, engine type data written in an engine ID area 40 can be loaded. The operation frequency of a main controller board and a RAM size are determined by loading data output from a clock generator and an SPD file of a RAMDIMM. In addition, a board ID unit 12 which stores an ID of the controller board, timer 1211, and power supply controller 1200 which controls electric power to be supplied to the respective units of the MFP are connected. The aforementioned devices are connected on a system bus 1207. Note that the controller 939 receives electric power when a main power supply is turned on. However, during an operation in the sleep mode, a power supply to blocks other than a network unit 1210 and those required to recover from the sleep mode is stopped. Reception of messages and the like from the LAN 3000 can be made even in the sleep mode, and a power supply to the controller 939 restarts in response to such reception.

An image bus I/F 1205 is a bus bridge which connects the system bus 1207 and an image bus 1208 which transfers image data at high speed, and converts a data structure. The image bus 1208 comprises a PCI bus or IEEE1394. On the image bus 1208, the following devices are connected. A raster image processor (RIP) 1260 rasterizes PDL code data to a bitmap image. A device I/F 1220 connects the scanner unit 10 and printer unit 20 as image input and output devices to the controller unit 30 to convert between a synchronous system and an asynchronous system. A scanner image processor 1280 applies correction, modification, and edit processes to input image data. A printer image processor 1290 applies correction, resolution conversion, and the like for a printer to print output image data. An image rotation unit 1230 rotates image data. An image compression unit 1240 executes compression and expansion processes for multi-valued image data using JPEG and for binary image data using JBIG, MMR, or MH.

A sub CPU 1320 in the FAX unit 940 serves as a facsimile image processor which analyzes facsimile data received via the public line 1251 and executes rasterization processing to bitmap data. A RAM 1330 is a work memory required to operate the sub CPU 1320, and a ROM 1340 stores a function program as the FAX unit. The controller 939 including the CPU 1201 and the like, and the FAX unit 940 are connected via a bus isolator 1310. The FAX unit 940 can be supplied the electric power independently of the controller 939. The power supply controller 1200 controls a power supply unit 1400 to control a power supply 1360 of the FAX unit 940, a power supply 1350 of the controller 939, a power supply to the printer unit 20 and scanner unit 10, and a power supply unit 1300 which supplies electric power to the operation unit 140. The bus isolator 1310 has a role of avoiding leakage of currents when a power supply to the power supply A 1350 is shut off while electric power is supplied to the power supply B 1360. A modem 1250 connects the public line 1251 to input and output information (e.g., facsimile data) via the public line.

<Processing in Master MFP>

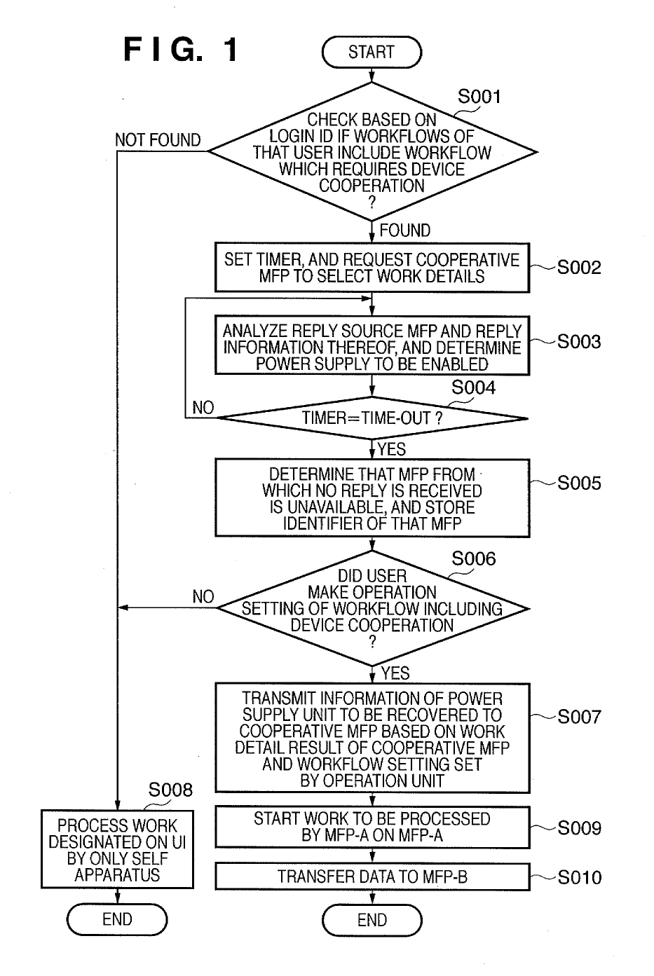

FIG. 1 is a flowchart which best illustrates a feature of the present invention, and shows the sequence to be executed by the CPU 1201 of the controller 939. The sequence shown in FIG. 1 is executed after the user's login process has succeeded via the operation unit 140. FIG. 1 exemplifies a case wherein the user logs in the MFP-A, and the MFP-A serves as a master MFP. When a certain user logs in the MFP-A and that login process has succeeded, the MFP-A refers to workflow information saved in association with the login user. The MFP-A checks if workflows defined by the workflow information associated with the login user include those which make a device cooperation (S001). Note that an MFP which is to undergo the device cooperation is a slave MFP, which is also called a cooperative MFP. To attain this checking process, the MFP-A saves the workflow information for respective workflows in association with an user ID. In step S001, the MFP-A compares the identifier of a hot folder source MFP included in the workflow information and that of the master MFP for each workflow. If the two identifiers are different from each other, the MFP-A can determine that the workflow of interest makes the device cooperation. If the corresponding workflow information is found, the MFP-A reads out that workflow information for later use. In this embodiment, step S001 corresponds to a determination unit/step which refers to the workflow information that defines a set of processes using the hot folder function, and determines a slave MFP that provides the hot folder function used in the workflow information.

If it is determined that a workflow which makes the device cooperation is found, the process branches to step S002. On the other hand, if it is determined that a workflow which makes the device cooperation is not found, the process branches to step S008.

In step S002, the MFP-A sets a predetermined appropriate time period in a timer, and issues a work detail notification request of a cooperative work to an MFP as a cooperative destination.

The MFP-A checks if each cooperative MFP returns a response to the work detail notification request in step S002, i.e., hot folder information (step S003). The MFP-A analyzes the returned work details, determines power supply units to be enabled in accordance with the work details, and saves that information (to be referred to as power supply unit information hereinafter) for each cooperative MFP. For example, assume that the work details, i.e., the process contents included in the hot folder information received from the MFP-B indicate “facsimile transmission”. In this case, the MFP-A determines that the power supply units to be enabled in the MFP-B are the power supply B 1360 of the controller and the power supply A 1350 of the facsimile unit. However, electric power is supplied to the controller even in the sleep mode (also called a halt mode), and enabling the power supply means recovery to a normal operation mode (running mode). For example, each MFP holds a table that associates the process contents and power supply units with each other and the like, and refers to that table to specify the power supply units based on the received work detail notification. In this embodiment, step S003 corresponds to a unit/step which acquires, from a slave image forming apparatus, process information indicating the process contents by the hot folder function provided by the slave image forming apparatus. Also, step S003 corresponds to a determination unit/step which determines processing units on hardware required for the hot folder function provided by the slave image forming apparatus based on information associated with the hot folder function received from the slave image forming apparatus.

The MFP-A checks in step S004 if the timer set in step S002 has reached a time-out. Note that the time-out of the timer is tested in a series of steps for the sake of descriptive convenience. However, processes until step S003 and those from step S005 may be independent from each other, and the processes after step S005 may be executed in response to a timer interruption. Also, if the work detail notifications are received from all cooperative MFPs in step S003, the process advances to step S005.

If replies from all cooperative MFPs are received and if the timer has reached a time-out, the process advances to step S005. If the set timer has not reached a time-out yet, and if there are MFPs from which no replies to the work detail notification request are received, the MFP-A waits for replies.

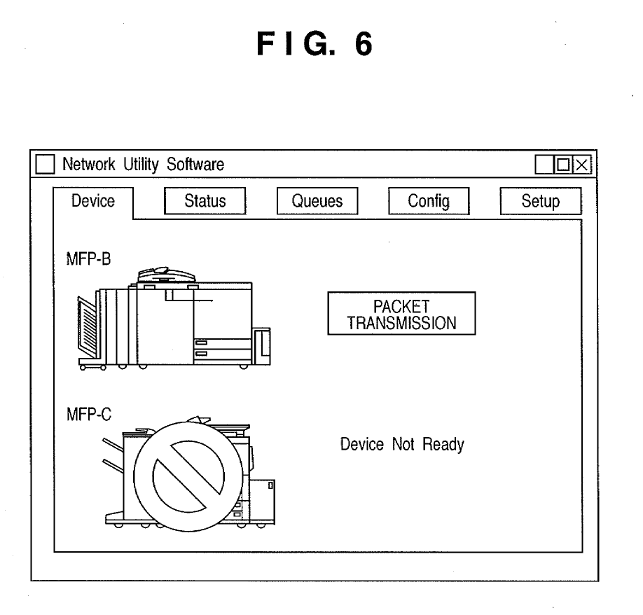

In step S005, the MFP-A determines that a cooperative MFP, from which no reply is received even after the time period set in the timer has elapsed, is unavailable. The MFP-A stores an identifier of the unavailable MFP. Also, the MFP-A displays the identifier and the like of the unavailable MFP on the operation unit 140 to inform the user of a message that advises accordingly. FIG. 6 shows a display example of that message. FIG. 6 displays that the MFP-C as a cooperative MFP is unavailable.

With the processes until step S006, the MFP-A displays, on the operation unit, workflows that the login user can execute. Note that the MFP-A does not display a workflow using the MFP which is determined to be unavailable in step S005, and does not allow the user to select it.

The MFP-A checks in step S006 if the user selected a workflow including a device cooperation via the operation unit. In other words, the MFP-A checks if the user selected a workflow that uses a hot folder defined by the cooperative MFP. If it is determined that the user selected a workflow including the device cooperation, the process branches to step S007. If the user did not select a workflow including the device cooperation, the process branches to step S008. Note that the workflow using the cooperative MFP is also called a process using a cooperative operation function.

In step S007, the MFP-A notifies each cooperative MFP of power supply information required to execute the workflow selected by the user as power supplies to be recovered based on the power supply information of that cooperative MFP saved in step S003. This notification is also called a power supply recovery request. For example, assume that information indicating the power supply B 1360 of the controller and the power supply A 1350 of the FAX unit is saved as the power supply unit information associated with hot folder A of the MFP-B. When the workflow of user's choice defines the use of hot folder A of the MFP-B, the MFP-A transmits information indicating the power supply B 1360 of the controller and the power supply A 1350 of the FAX unit as power supplies to be recovered to the MFP-B as a cooperative MFP. Upon reception of the power supply information, the cooperative MFP enables the power supply units designated by that information. In this embodiment, step S007 corresponds to a recovery request unit/step which transmits a recovery request to recover power supplies of the determined processing units to a normal running state to the slave image forming apparatus which provides the hot folder function used in the workflow information.

Note that the MFP-A transmits a power supply recovery request at the time of selection of the workflow in step S007. Alternatively, the MFP-A may check if a process step in which a recovery request is to be transmitted is reached. If it is determined that a process step in which a recovery request is to be transmitted is reached, the MFP-A may transmit the recovery request. The process step in which the power supply recovery request is to be transmitted is that to be executed before a process step of transmitting data to a slave MFP. The power supply recovery request may be transmitted at the time of completion of that process step or at a predetermined timing (e.g., at the time of completion of the first process step).

In step S009, the MFP-A executes operations to be processed by itself of the workflow selected via the operation unit. The MFP-A executes the selected workflow. Note that the workflow includes a plurality of process steps, and the MFP-A calls required modules based on the process contents of the respective process steps and sequentially executes the processes of the respective process steps.

In step S010, the MFP-A executes the processes for respective steps of the workflow, and if a step to be executed is a step of transmitting data to be processed to a cooperative MFP, the MFP-A transmits data based on the details executed until that transmission step. Of course, the MFP-A also transmits information that designates a hot folder defined by the workflow based on the hot folder information. The data to be transmitted may be data processed by the MFP-A in step S009 or data simply read out from a file. This depends on the definition of the workflow. Step S010 corresponds to a data transmission unit/step in which the MFP-A transmits data to be processed by the hot folder function provided by the slave MFP to that slave MFP after the recovery request unit transmits the recovery request.

Upon reception of the data, the cooperative MFP inputs the received data to the designated hot folder, and executes the process associated with that hot folder. At this time, the cooperative MFP has already received the power supply recovery information from the master MFP, and has already executed the power supply recovery operation for hardware resources used in the workflow. If the power supply recovery operation is complete, the process associated with the hot folder can be started immediately after data reception. Even if that operation is not complete yet, since the recovery operation has already been started, the wait time can be shortened. Furthermore, since the power supply units to be used in the process are specified and recovered, the power saving effect can be improved.

On the other hand, if the workflow selected by the user does not include any cooperative operation function in step S006, the MFP-A executes a work selected on the operation unit by itself in step S008.

Note that the sequence upon processing the workflow has been described. The workflow is not limited to continuous execution of a plurality of process units, but it includes general processes to be executed by the MFP such as a single process, processes including a cooperative operation, and the like.

### PRACTICAL EXAMPLE

The operations of the MFPs of this embodiment will be described below taking a more practical example. Assume that there is an office in which the MFP-A, MFP-B, MFP-C, and MFP-D are connected to the LAN 3000, as shown in FIG. 2. At this time, assume that the MFP-C is OFF.

Assume that the user who has a right of use of a workflow including a device cooperation in such office logs in using the operation unit 140 of the MFP-A. Then, the CPU 1201 checks based on the user ID input from the operation unit 140 if operation unit setting information for each user ID stored in the HDD 1204 includes customized operation unit settings and workflows. Then, the CPU 1201 confirms the set workflow details to determine MFPs and cooperative operations indicated by the details. For example, assume that a cooperative operation workflow including a step of transferring document data to a hot folder of the MFP-B, and that including a step of transferring document data to a hot folder of the MFP-C (S001).

Then, the controller unit 30 of the MFP-A sets a predetermined time period in the timer 1211. The MFP-A requests the MFP-B and MFP-C connected to the LAN 3000 via the network unit 1210 to notify the work details of their hot folders (S002).

Upon reception of the notification request from the MFP-A via the LAN 3000, the MFP-B controls the power supply controller 1200 to recover a night-system power supply for the CPU, RAM, and the like when the network unit 1210 having a WOL (WakeOnLAN) function receives a packet addressed to the self apparatus. The MFP-B controls the CPU 1201 in the unit to reply the work details of hot folders stored in the HDD 1204. For example, the MFP-B sends a reply indicating that hot folder A of its hot folders is associated with FAX, hot folder B is associated with printing, and hot folder C is associated with e-mail transmission. After the reply is sent, the MFP-B shifts to the sleep mode.

On the other hand, the MFP-C cannot return any response to a reply request since it is OFF.

Upon reception of the reply, the MFP-A determines power supplies to be enabled at the time of recovery from the sleep mode based on the work details of hot folders transmitted from the MFP-B (S003). For example, if folder A is associated with a FAX transmission flow, the power supplies for the controller unit 30 and FAX unit 940 are to be enabled. If folder B is associated with a print flow, the power supplies for the controller unit 30 and printer unit 20 are to be enabled. If folder C is mail transmission flow, the power supply of only the controller unit 30 is to be enabled.

The MFP-A waits for a response from the MFP-C for the time period determined in step S002 (S004). If no response is returned from the MFP-C even after the time period specified by the timer setting value has elapsed, the MFP-A determines that the MFP-C is unavailable (S005).

The MFP-A then displays workflows that the login user can select. The MFP-A checks if the user selects the workflow including the step of transferring data to a hot folder of the MFP-B on the operation unit 140 (S006).

If the user selects the workflow including the step of transmitting data to folder A, the MFP-A reads out information required for the work of folder A at the time of recovery from the sleep mode, which is analyzed in step S003. The MFP-A sends the readout information to the MFP-B via the LAN 3000 to request it to enable power supplies of modules required for the work of folder A (S007).

Upon reception of the request, the MFP-B controls the CPU 1201 to interpret the partial recovery request sent from the MFP-A. The MFP-B issues an instruction to the power supply controller 1200 to operate the power supply units 1300 and 1400. With this operation, the MFP-B recovers the power supply of only the FAX unit 940 without enabling those of the scanner unit 10, printer unit 20, and operation unit 140.

The MFP-A executes a step to be processed by itself included in the workflow, and transfers data to the hot folder (folder A) in the HDD 1204 of the MFP-B via the LAN 3000 (S009 and S010).

Since the data is input to the hot folder, the MFP-B executes the workflow (e.g., FAX transmission) associated with that folder.

If no workflow using a cooperative MFP can be detected or if no cooperative operation is set in the operation unit settings, the MFP-A processes the workflow set using the operation unit 140 by only itself.

As described above, the master MFP refers to the work details of a hot folder of a cooperative (slave) MFP, and can recover power supplies of only components (hardware) required for the work on the slave MFP. For this reason, consumption power savings and prevention of delay of the processing time can be achieved at the same time.

Note that the work detail notification transmitted from the cooperative MFP in step S003 in FIG. 1 need not always include the data storage address 703 of information included in the hot folder information. However, if a communication medium is not a LAN but is a bus (e.g., IEEE1394 or the like), the address is required.

### Second Embodiment

In step S003 of the first embodiment, information returned from the slave MFP is work information of a hot folder (hot folder information), and the master MFP makes a decision of power supplies to be enabled associated with resources used in the hot folder.

By contrast, in this embodiment, the slave MFP-B which is requested to recover from the sleep mode transmits information corresponding to power supplies to be enabled (which is also called power supply unit information) to the master MFP-A.

For example, the MFP-B adds, to a recovery packet, data 001b (“b” following numerals is indicative of a binary number) if data is to be transferred to hot folder A, 010b if data is to be transferred to hot folder B, and 100b if data is to be transferred to hot folder C, and then transmits the recovery packet.

When the user selects a workflow including a step of transferring data to hot folder A of the MFP-B on the operation unit 140, the MFP-A adds the data 001b notified by the MFP-B to a power supply recovery request, and transmits the request to the slave.

As described above, the master MFP need not analyze power supplies to be enabled when the slave MFP recovers from the sleep mode. In the slave MFP, the CPU 1201 compares the received data pattern with a pattern of power supplies to be enabled stored in the HDD 1204, and recovers only power supplies corresponding to the data pattern from the sleep mode.

With this method, since the master MFP need not analyze power supplies to be enabled at the time of recovery from the sleep mode, only required components can be recovered even between models with different configurations (e.g., a latest model and old model).

### Third Embodiment

In this embodiment, upon power ON of the MFP (e.g., MFP-B), the MFP-B broadcasts work information in hot folders (hot folder information) and power supply unit information of each hot folder to other MFPs. The power supply unit information is data indicating hardware components so as to recover only hardware components required for the processing of a given hot folder from the sleep mode.

When the other MFP which received that packet selects the transmission source MFP as a slave, it transmits the power supply unit information which is broadcasted in advance together with a power supply recovery request. In this way, the slave MFP can recover power supplies of only required components.

When the MFP-B receives hot folder information and power supply unit information broadcasted from the MFP-C upon power ON of the MFP-C, the transmission source MFP-C is unlikely to receive the hot folder information and power supply unit information from the MFP-B. Hence, upon reception of the hot folder information and power supply unit information from another MFP, the MFP unicasts hot folder information and power supply unit information to that MFP. This unicast is made only upon reception of the broadcasted information, and the hot folder information and power supply unit information are not transmitted in response to the unicasted hot folder information and power supply unit information. This is to prevent endless repetitions.

In this way, information of power supplies to be enabled at the time of recovery from the sleep mode can be acquired before the user logs in.

The arrangement of the third embodiment discloses a unit/step which receives and saves process information which is broadcasted upon power ON of the slave image forming apparatus and indicates the process contents of the hot folder function provided by the slave image forming apparatus.

### Fourth Embodiment

In this embodiment, upon detection of cooperative MFPs in the first to third embodiments, the master MFP requests the cooperative MFPs to return their status data via the LAN 3000. The master MFP then displays the device status data of the cooperative MFPs, e.g., the MFP-B and MFP-C on the operation unit 140. At this time, if an MFP from which no reply is received is found, the master MFP displays an identification name indicating that MFP (e.g., MFP-C). In this manner, the workflow including the cooperative work can be prevented from being interrupted.

### Fifth Embodiment

The first to fourth embodiments are premised on that the hot folders of the slave MFPs (other MFPS) are used. However, a description of this embodiment will be given under the assumption that hot folders of the slave MFPs are not used.

The master MFP to which the user logs in specifies workflows that the login user can execute, and checks if the specified workflows include that which requires cooperation with a slave MFP.

If a workflow that requires cooperation with a slave MFP is found, the master MFP specifies the process contents to be executed by the slave MFP in that workflow.

The master MFP determines processing units on hardware required for the slave MFP to execute the process based on the specified process contents to be executed by the slave MFP. Note that this determination process is basically the same as that in step S007 in FIG. 1 described above.

Upon execution of the workflow including the process step using the function of the slave image forming apparatus, the master MFP transmits a recovery request to the slave image forming apparatus to recover the power supplies of the determined processing units to a running mode.

According to this embodiment, by interpreting the workflow, the master MFP can specify a function required for the process step to be executed by the slave image forming apparatus, and can recover the processing units required to execute that function.

As a result, since the workflow can be smoothly executed, and only the required processing units are recovered, the power saving effect can be improved.

Note that the present invention may be applied to either a system constituted by a plurality of devices (e.g., a host computer, interface device, reader, printer, and the like), or an apparatus consisting of a single equipment (e.g., a copying machine, facsimile apparatus, or the like). The objects of the present invention are also achieved by supplying a storage medium, which records a program code of a software program that can implement the aforementioned functions to the system, and reading out and executing the program code stored in the storage medium by the system. In this case, the program code itself read out from the storage medium implements the functions of the aforementioned embodiments, and the storage medium which stores the program code constitutes the present invention.

Also, the present invention includes a case wherein an operating system (OS) running on a computer executes some or all of actual processing operations based on an instruction of the program code to implement the aforementioned functions. Furthermore, the present invention also includes a case wherein the program code read out from the storage medium is written in a memory equipped on a function expansion card or function expansion unit which is inserted in or connected to the computer. Then, a CPU or the like equipped on the function expansion card or unit executes some or all of actual processing operations to implement the aforementioned functions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-011953, filed Jan. 22, 2007, which is hereby incorporated by reference herein in its entirety.

What is claimed is:

1. An image forming apparatus, which can communicate with another image forming apparatus that executes a process based on a hot folder function of applying a predetermined process to data input to a predetermined storage location, and which can execute a workflow as a set of processes by combining a plurality of process steps, said apparatus comprising:
a determination unit adapted to determine a processing unit required for the process using the hot folder function provided by the other image forming apparatus based on information associated with the hot folder function received from the other image forming apparatus;
a request unit adapted to transmit, when a workflow including a process step using the hot folder function is selected, a recovery request, which requests to recover a power supply of the processing unit determined by said determination unit to a running mode, to the other image forming apparatus that provides the hot folder function; and
a data transmission unit adapted to transmit data to be processed by the hot folder function provided by the other image forming apparatus to the other image forming apparatus after said request unit transmits the recovery request.

2. The apparatus according to claim 1, further comprising a first discrimination unit adapted to discriminate another image forming apparatus which provides a hot folder function used in workflow information with reference to the workflow information including a process step using the hot folder function,
wherein said determination unit acquires process information indicating process contents required to execute the hot folder function provided by the other image forming apparatus from the other image forming apparatus discriminated by said first discrimination unit, and determines a processing unit required for the hot folder function provided by the other image forming apparatus based on the acquired process information.

3. The apparatus according to claim 1, wherein said determination unit acquires information indicating a processing unit required to execute the hot folder function provided by the other image forming apparatus from the other image forming apparatus.

4. The apparatus according to claim 1, further comprising a reception unit adapted to receive process information which is broadcasted from the other image forming apparatus and indicates process contents of the hot folder function provided by the other image forming apparatus,
wherein said determination unit determines a processing unit required for the hot folder function provided by the other image forming apparatus based on the process information which is received from the other image forming apparatus and indicates the process contents by the hot folder function provided by the other image forming apparatus.

5. The apparatus according to claim 1, further comprising:
an execution unit adapted to execute the workflow including the plurality of process steps; and
a second discrimination unit adapted to discriminate if a process step of transmitting the recovery request is reached in the workflow executed by said execution unit,
wherein when said second discrimination unit discriminates that the process step of transmitting the recovery request is reached, said request unit transmits the recovery request.

6. An image forming apparatus, which can communicate with another image forming apparatus and can execute a workflow as a set of processes by combining a plurality of process steps, said apparatus comprising:
a determination unit adapted to determine, based on process contents of a process step which is included in the workflow and uses a function of the other image forming apparatus, a processing unit required for the other image forming apparatus to execute a process of the process step;
a request unit adapted to transmit, when the workflow including the process step using the function of the other image forming apparatus is executed, a recovery request, which requests to recover a power supply of the processing unit determined by said determination unit to a running state, to the other image forming apparatus; and
a data transmission unit adapted to transmit data to be processed by the other image forming apparatus to the other image forming apparatus after said request unit transmits the recovery request.

7. A method of controlling an image forming apparatus, which can communicate with another image forming apparatus that executes a process based on a hot folder function of applying a predetermined process to data input to a predetermined storage location, and which can execute a workflow as a set of processes by combining a plurality of process steps, said method comprising:
a determination step of determining a processing unit required for the process using the hot folder function provided by the other image forming apparatus based on information associated with the hot folder function received from the other image forming apparatus;
a request step of transmitting, when a workflow including a process step using the hot folder function is selected, a recovery request, which requests to recover a power supply of the processing unit determined in the determination step to a running mode, to the other image forming apparatus that provides the hot folder function; and
a data transmission step of transmitting data to be processed by the hot folder function provided by the other image forming apparatus to the other image forming apparatus after the recovery request is transmitted in the request step.

8. A method of controlling an image forming apparatus, which can communicate with another image forming apparatus and can execute a workflow as a set of processes by combining a plurality of process steps, said method comprising:
a determination step of determining, based on process contents of a process step which is included in the workflow and uses a function of the other image forming apparatus, a processing unit required for the other image forming apparatus to execute a process of the process step;
a request step of transmitting, when the workflow including the process step using the function of the other image forming apparatus is executed, a recovery request, which requests to recover a power supply of the processing unit determined in the determination step to a running state, to the other image forming apparatus; and
a data transmission step transmitting data to be processed by the other image forming apparatus to the other image forming apparatus after the recovery request is transmitted in the request step.

9. A computer-readable storage medium storing a program for making a computer, which can communicate with another image forming apparatus that executes a process based on a hot folder function of applying a predetermined process to data input to a predetermined storage location, and which can execute a workflow as a set of processes by combining a plurality of process steps, function as:
a determination unit adapted to determine a processing unit required for the process using the hot folder function provided by the other image forming apparatus based on information associated with the hot folder function received from the other image forming apparatus;
a request unit adapted to transmit, when a workflow including a process step using the hot folder function is selected, a recovery request, which requests to recover a power supply of the processing unit determined by said determination unit to a running mode, to the other image forming apparatus that provides the hot folder function; and
a data transmission unit adapted to transmit data to be processed by the hot folder function provided by the other image forming apparatus to the other image forming apparatus after said request unit transmits the recovery request.
